(19) United States
(12) Patent Application Publication
(10) Pub. No.: US 2002/0094076 A1
(43) Pub. Date: Jul. 18, 2002

(54) Telephone caller identification control

(76) Inventor: Han-ping Chen, Saratoga, CA (US)

Correspondence Address: Han-ping Chen, P.O. Box 2871, Saratoga, CA, 95070, US

(21) Appl. No.: 09/761,673

(22) Filed: Jan. 18, 2001

(51) Int. Cl. H04M 1/00; H04M 3/00

(52) U.S. Cl. 379/373.01; 379/142.04

(57) ABSTRACT

A method and apparatus controls the telephone call announcement and response according to the caller identification or caller-waiting identification, said announcement includes an audible sound such as a music sequence, a ringing signal, a voice segment, or a combination of sounds, some of which may contain caller description, caller group description, or called party description.

### BACKGROUND OF THE INVENTION

This invention relates to telephone caller identification, announcement, and the handling of telephone calls.

Caller identification is a service available from many telephone companies for customers to screen telephone calls. The caller identification is sent to the receiving telephone station during the ringing time. The receiving station displays the caller identification before answering the call.

To see the caller id when a telephone rings, the user must be nearby a display device. In many cases, they must pause the current activity and go to the location of a display device. During night hours, a display device may not be clearly visible without turning on the light.

If there are two or more persons in a household, a user may also find the call to be addressing someone else in the household. Each member of the household needs to review the caller id to properly screen an incoming call.

To serve the vast majority of the population, a solution to this problem needs to be user-friendly, compatible with existing installation, and affordable by most users.

It is also important for such a solution to provide the needed clarity in caller identification, yet with enough privacy for the caller and the called party.

### BRIEF SUMMARY OF THE INVENTION

This invention proposes a method and apparatus to announce telephone callers using audible sounds such as music sequences.

This invention provides an announcement method that is user-friendly and easy-to-operate with little or no human intervention. It is also affordable in cost for most users.

It is the objective of the present invention to provide an announcement method that is compatible with existing telephone wiring. It is also compatible with other telephone devices such as a telephone set, an answering machine, a fax machine, or a computer interface device.

The present invention proposes a method with enough variety and clarity so that it is easily recognizable by a potential called party. It also proposes a method to control the level of privacy for the caller and the called party in case some other guests may be present in the house.

This invention further provides a method for the system to automatically initialize and train itself to handle subsequent operations.

This invention also provides a method for the user to manually edit the list of expected callers, the assignments of caller announcements, the system control settings, and the composition of audible sounds.

### BRIEF DESCRIPTION OF THE DRAWINGS

FIG. 1 is a diagram of a prior art caller identification device with a telephone set.

FIG. 2 shows a preferred embodiment of the present invention for a telephone caller identification control system.

FIG. 3 is a preferred embodiment of a flowchart for the major processes of a telephone caller identification control system.

FIG. 4 is a preferred embodiment of a flowchart for call processing in the telephone caller identification control system.

FIG. 5 is a preferred embodiment of a flowchart for command processing in the telephone caller identification control system.

FIG. 6 is a preferred embodiment of a flowchart for a telephone caller identification control system to perform fully automatic operation.

FIG. 7 describes a preferred embodiment of a flowchart for a telephone caller identification control system to perform operation with minimal user interventions.

FIG. 8 shows a preferred embodiment of the present invention for a telephone caller identification control system with master and slave devices.

### DETAILED DESCRIPTION OF THE INVENTION

The present invention will be illustrated with some preferred embodiments.

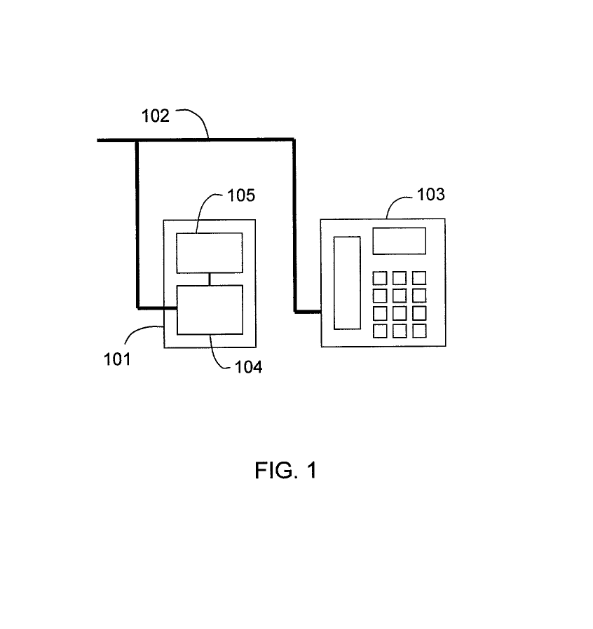

FIG. 1 is a diagram of a prior art caller identification device with a telephone set. The caller identification device 101 is connected to the telephone line 102, in parallel with the telephone set 103.

The caller identification unit 104 extracts caller identification information from the telephone line and sends the information to display on a display unit 105.

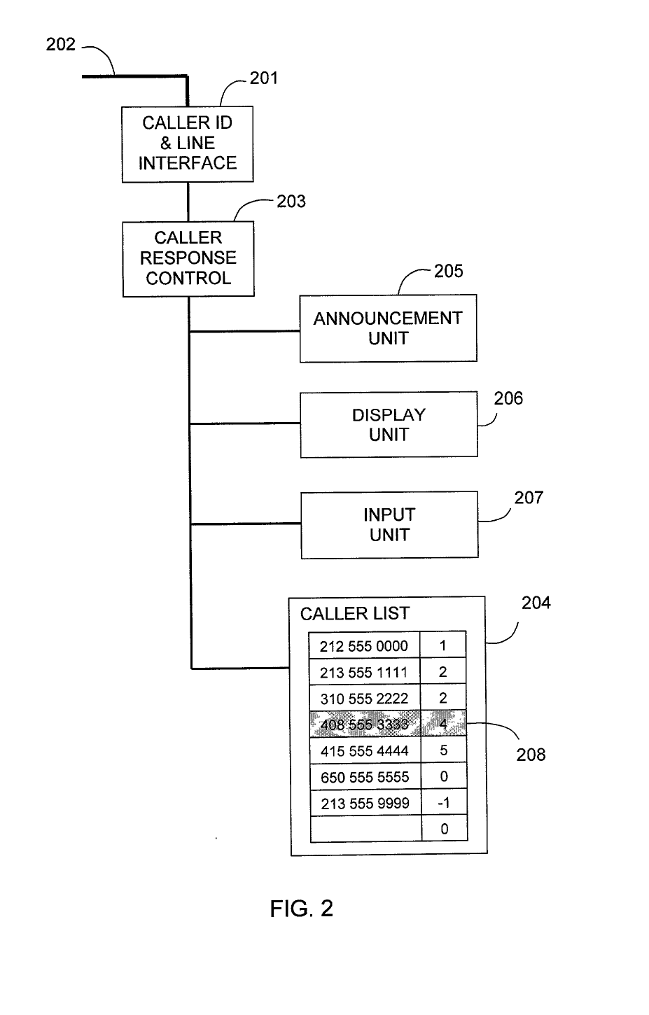

FIG. 2 is a preferred embodiment of the present invention for a telephone caller identification control system. The caller id and line interface unit 201 extracts the caller identification or caller-waiting identification information from the telephone line 202.

The extracted caller identification is sent to the caller response control unit 203. The caller response control unit 203 checks the caller identification with a caller list 204, which contains a list of expected callers.

Each entry in the caller list 204 contains a caller id number and a control tag. The control tag may specify an index code for a music sequence. It may also contain a code indicating that the call is not to be announced. The control tag may also identify recent calls by the receiving order.

If the caller id matches an expected caller in the list, the caller-response control unit 203 sends the appropriate control signals according to the control tag to the announcement unit 205 for audible announcement.

The caller response control unit may also send control signals to the display unit 206 for optional visual display.

There is a way for the caller response control unit to automatically initialize and train the system to handle the operations without user interventions.

However, a user may also enter commands through an optional input unit 207 to edit the contents of the caller list or to change other system control settings.

To illustrate the system operation, assume that the caller list 204 contains the entries as shown in the diagram. In this example, a control tag with the value 0 specifies a caller id that is not to be announced. A control tag with a positive value specifies an index code for a music sequence. A control tag with a negative value specifies a recent caller id by the receiving order.

Assume that the calling number matches the shaded entry 208. The corresponding control tag contains an index code of 4. The caller response control unit 203 will instruct the announcement unit 205 to announce the telephone with music sequence number 4.

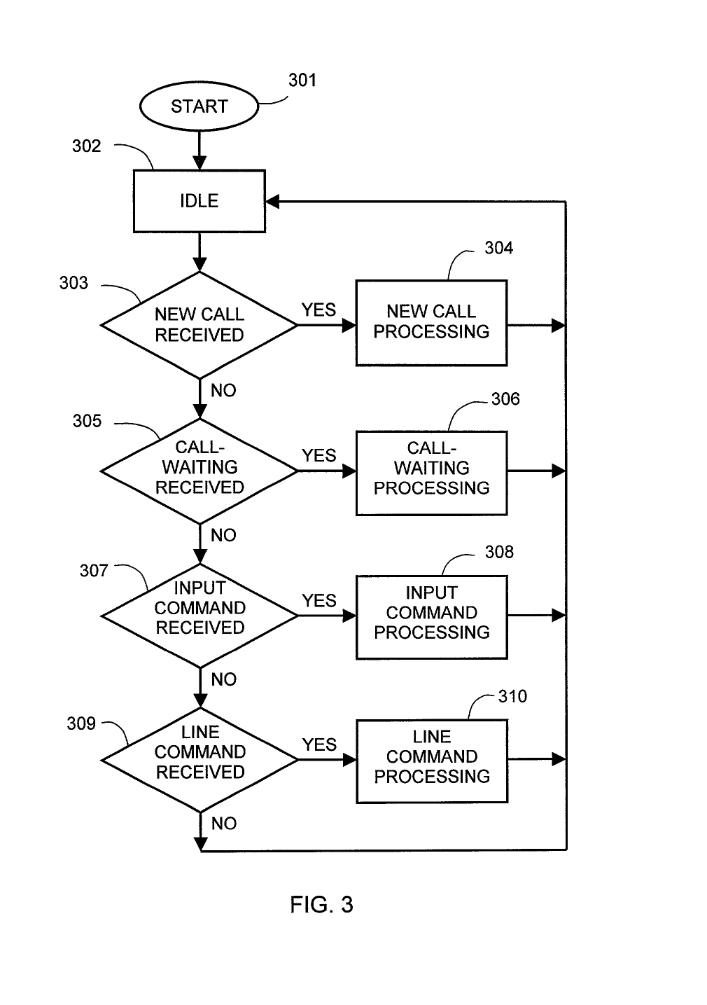

FIG. 3 is a preferred embodiment of a flowchart for the major processes of a telephone caller identification control system. The system begins with a starting state 301 after power-up. It performs the necessary initialization and enters an idle state 302.

If a new call is detected in state 303 through a ring indicator, the system enters a new call processing state 304 to process the new call.

If a call-waiting condition is detected in state 305 during a telephone call, the system enters a call-waiting processing state 306 to process the call-waiting condition.

If a user input is detected in state 307, the system enters an input command processing state 308 to process the input command.

If an inline command is detected in state 309, the system enters a line command processing state 310 to process the input command.

The processing states 304, 306, 308, and 310 will be further described. After these processing states, the system returns to the idle state 302 to perform other operations.

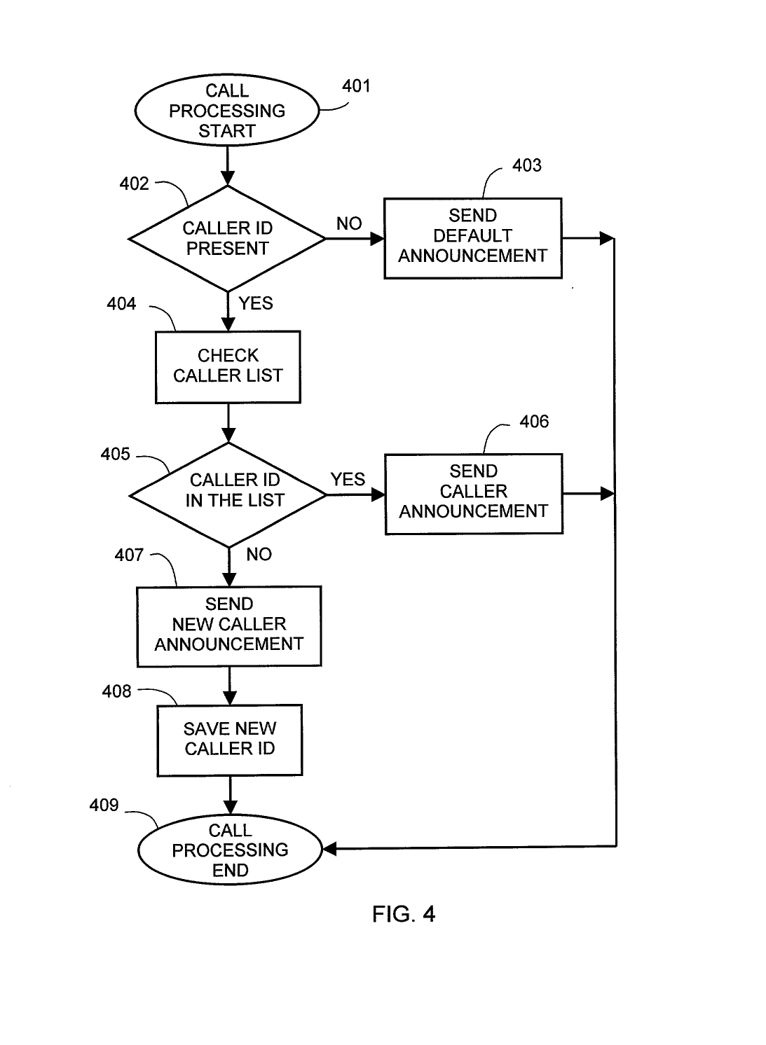

FIG. 4 is a preferred embodiment of a flowchart for call processing of a telephone caller identification control system. It describes either a new call processing procedure or a call-waiting processing procedure.

The call processing begins with a starting state 401. In state 402, the system determines whether there is a caller id present or not. A caller id may not be available in some areas, for some telephone companies, or for some PBX systems. A caller may also block the caller identification.

If the caller id is not present, the system enters state 403. In state 403, it either does not response to the telephone call or it may announce the telephone call with a default announcement. If a no-id condition and a blocked-id condition are distinguishable, they may be announced with different default announcements.

If the caller id is present, the system enters state 404 to check the caller id with the caller list for a possible match.

In state 405, the system determines whether the caller id is an active entry with a positive index code for an announcement. If so, it enters state 406 to send the corresponding announcement to the announcement unit.

If the caller id is not an active entry in the caller list, it enter state 407. In state 407, it may announce the call with a new-call announcement.

In state 408, the system saves the new caller id as a recent caller id. The saved caller id may be further processed automatically by the system or manually by the user through input commands or inline commands.

At the end of call processing 409, the system returns to the major process loop for other operations.

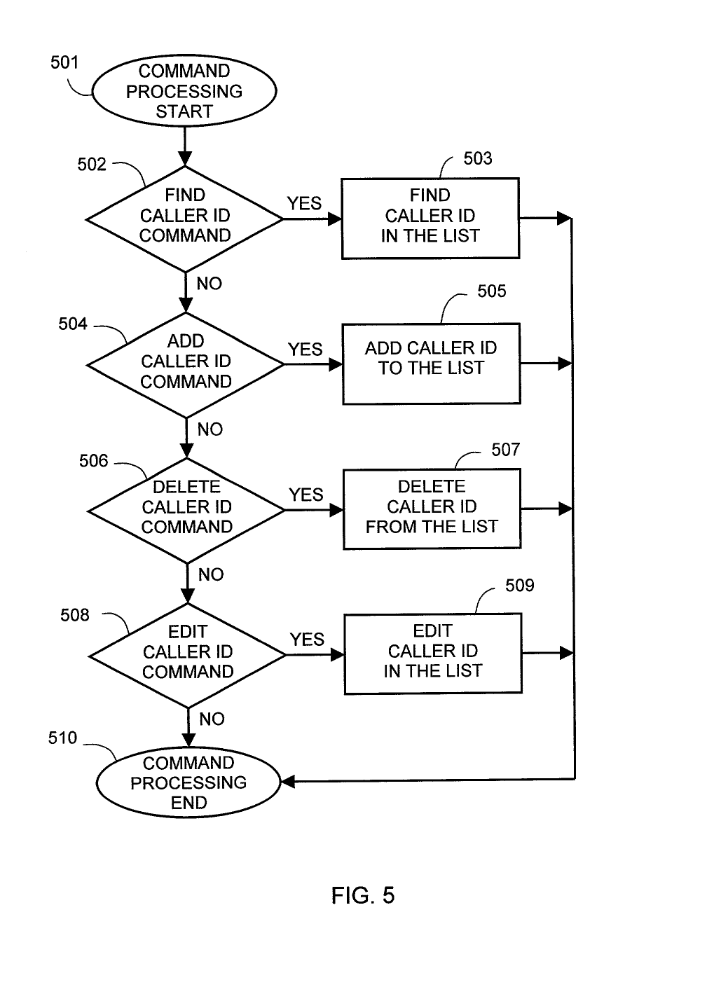

FIG. 5 is a preferred embodiment of a flowchart for command processing of a telephone caller identification control system. It describes either an input command processing procedure or an inline command processing procedure.

The call processing begins with a starting state 501. In state 501, the system points to the most recent call id from either an incoming call or an outgoing call. This caller id is designated as the current caller id for further processing.

If a find-caller-id command is detected in state 502, the system enters state 503 to find a caller id in the list. The system may move the caller id pointer up and down the recent caller entries and other active entries in the caller list.

It may also accept a caller id entry from the user. This caller id entry may be used as a new caller id or as a search key to find an entry in the caller list.

If an add-caller-id command is detected in state 504, the system enters state 505 to add the current caller id to the caller list.

If a delete-caller-id command is detected in state 506, the system enters state 507 to delete the current caller id from the caller list.

If an edit-caller-id command is detected in state 508, the system enters state 509 to edit the current caller id in the caller list. The user may modify the control tag of the current caller id to a specified value.

At the end of command processing 510, the system returns to the major process loop for other operations.

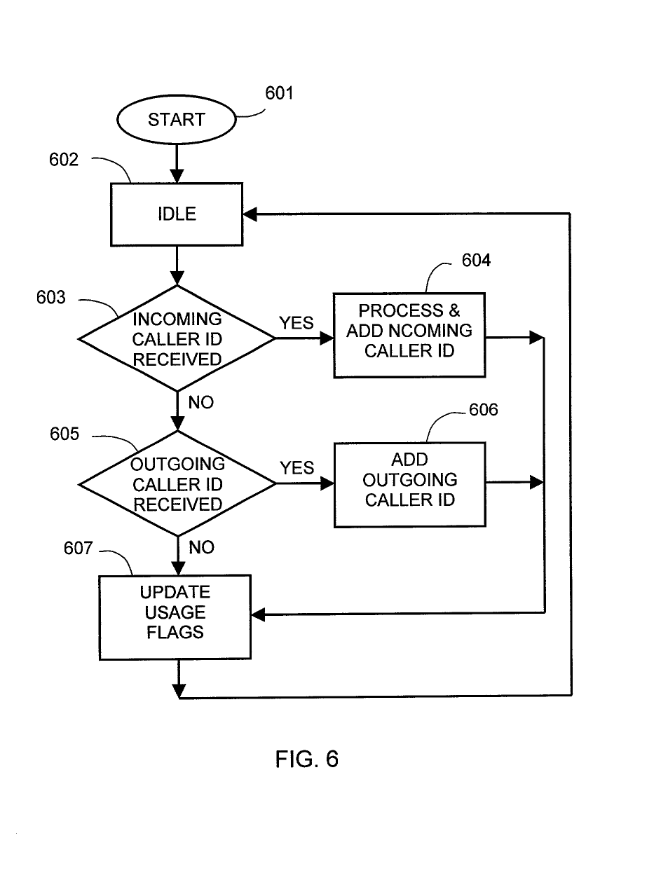

This invention provides a fully automatic operation in which it requires no human intervention. FIG. 6 describes a preferred embodiment of a flowchart for this fully automatic operation.

When the system is first placed into service, it begins with a starting state 601. In the stating state, the caller list contains no caller id entries. After initialization, the system enters an idle state 602.

For an incoming call in state 603, the system enters state 604 to process the caller id and announces the call accordingly. If it is a new caller id and the user accepts the call, this caller id will be added to the caller list. The position of the entry in the caller list will be used as a default announcement index code.

The control tag of an entry will be used to specify a usage flag for the system to find the least-recently-used entry. The usage flags for all the entries will be updated in state 607 each time a new entry is added to the list. The most-recently-used entry contains the value −1. The least-recently-used entry contains the largest negative value, which corresponds to the total number of valid entries in the list.

When the caller list is full, a new entry will replace the least-recently-used entry, as specified in the control tags.

For an outgoing call in state 605, the caller id will also be added to the caller list in state 606. Again, the position of the entry in the caller list will be used as a default announcement index code. The control tags of the entries are also updated accordingly in state 607.

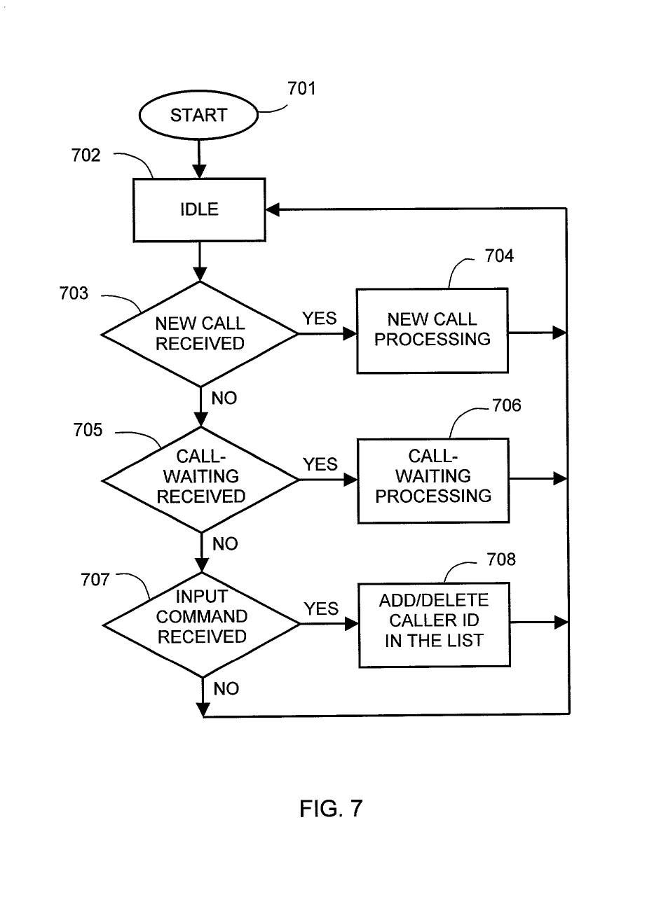

This invention also supports an almost fully automatic operation in which it requires only minimal human interventions. FIG. 7 describes a preferred embodiment of a flowchart for this almost fully automatic operation.

The system begins with a starting state 701 after power-up. After the initialization, the system enters an idle state 702.

If a new call is detected in state 703 through a ring indicator, the system enters a new call processing state 704 to process the new call.

If a call-waiting condition is detected in state 705 during a telephone call, the system enters a call-waiting processing state 706 to process the call-waiting condition.

This system only requires minimum user interventions in state 707 to add or delete the most recent incoming or outgoing caller id in state 708.

Sophisticated users may use a more generalized user command set to scan through the active caller and recent caller id list, to search for a particular caller id, or to edit the control tags of the caller id entries.

A system may contain a large number of announcement signal types, indexed by the index codes of the caller id entries. The announcement signal may be an easily recognizable music sequence.

A user may assign a special announcement sequence to each caller id on a one-to-one basis. They may also assign the same announcement sequence to more than one caller ids to specify a group of caller ids. The announcement signal may be associated to the group for easy recognition.

To accomplish this, the system provides the capability for a user to modify the index codes of caller id entries as well as the music sequence specification of a particular index code.

To further simplify the system settings, this invention provides the capability for commands to be entered either through the input unit or through the telephone line. When enabled, this system accepts system commands from either a local telephone set or a remote telephone set.

With an optional ring suppressor, or when incorporated within a telephone set, the present system may replace the ordinary ring announcement with the new announcements.

As an alternative to the music sequences, each caller id or caller id group may be assigned a special ring pattern.

However, the number of easily recognizable ring patterns is not as large as music sequences. The number of caller id group is thus limited to only a handful.

Likewise, a caller id or caller id group may be assigned a ring signal plus a designated music sequence so that it sounds like an ordinary telephone ring with a special personalized note.

To announce a telephone call in a more explicit fashion, a caller id or caller id group may be assigned a voice announcement, which may include the name of the caller, the description of the caller group, or the name of the called party. For example, the announcement unit may announce: “Call for A”, “Call for A from B”, or “Call for A from B, a chorus member”. It may also announce: “Fax from C”.

Explicit announcement has its shortcomings. It requires more memory and other system resources. It is more difficult to set up and operate. In some case, the called party may prefer more privacy if there are other guests in the house.

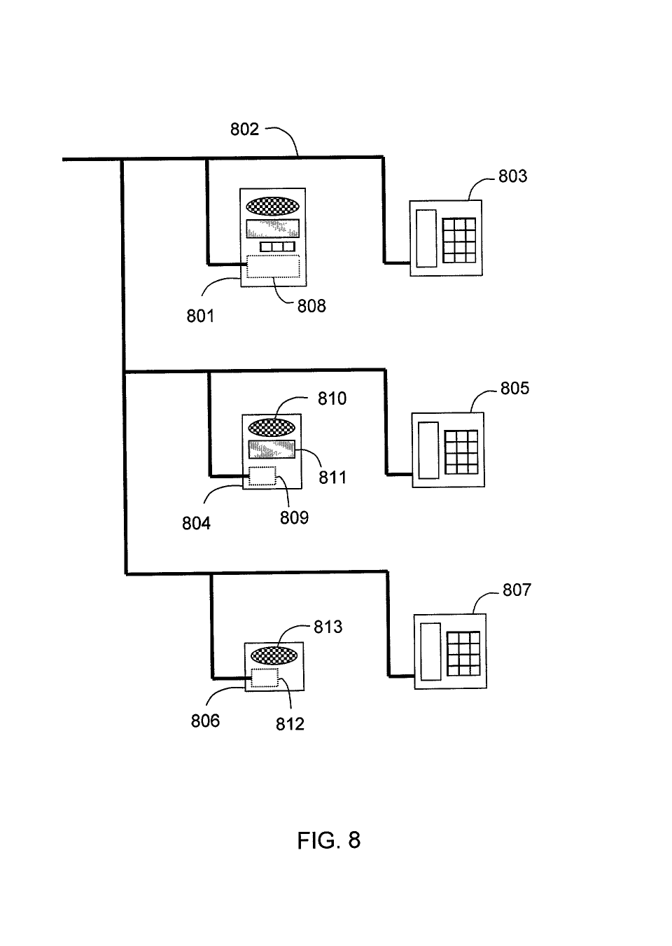

FIG. 8 shows a preferred embodiment of the present invention for a telephone caller identification control system with master and slave devices.

A master caller announcement device 801 is connected to the telephone line 802, in parallel with the telephone set 803. A slave device 804 is connected to the telephone line 802, in parallel with the telephone set 805. Another slave device 806 is also connected to the telephone line 802, in parallel with the telephone set 807.

The master device 801 performs the caller identification, announcement, and editing operations as described above. It further sends announcement control signals through the line interface unit 808 and the telephone line 802 to slave devices 804 and 806.

This function does not require additional hardware since the system already has a caller id and line interface unit that contains the circuits for sending and receiving frequency-shift keying signals on the telephone line.

Slave device 804 contains a line interface unit 809, a local announcement unit 810, and a local display unit 811. The line interface unit receives the announcement control signals and delivers the information to the local announcement unit and the local display unit. This type of slave device requires less memory to operate. The control circuit is also simpler than the master device.

Slave device 805 contains a line interface unit 812 and a local announcement unit 813. The line interface unit receives the announcement control signals and delivers the information to the local announcement unit. This type of slave device is even simpler than the one before.

The most important reason for a master-slave arrangement is to centralize the maintenance of caller id control information at the master device. Another reason is to provide a cost-effective way to distribute the caller announcement.

A telephone caller identification control system may also contain more than one master device. The system can provide automatic or manual synchronization of caller id control information.

I claim:

1. A telephone caller identification control device, module, subsystem, or system unit comprising:
(a) means for extracting caller identification or caller-waiting identification information from a telephone line;
(b) means for announcing a telephone call with a plurality of audible announcement sounds;
(c) means for assigning a plurality of expected caller identifications to a plurality of said audible announcement sounds;
wherein said audible announcement sound is a music sequence or a combination of a music sequence and a ringing pattern;
wherein the caller identification control unit announces a telephone call with a first announcement sound for a first expected caller id;
wherein the caller identification control unit announces a telephone call with a second announcement sound for a second expected caller id;
wherein the caller identification control unit announces a telephone call with a third announcement sound for a third expected caller id.

2. The telephone caller identification control unit of claim 1 wherein the caller identification control unit either does not announce or announces with a fourth announcement sound for a telephone call that does not contain an expected caller identification.

3. The telephone caller identification control unit of claim 1 further comprises means to locally or remotely initialize or revise the expected caller list, the announcement sound assignments, or the announcement sound specifications when the telephone is in calling mode, receiving mode, or idle mode.

4. The telephone caller identification control unit of claim 1 further comprises means for receiving caller identification information or caller announcement assignment either on the telephone line or from user commands on the telephone console, and responding to such information accordingly, before or after the telephone is answered by the user or an automatic answering mechanism.

5. The telephone caller identification control unit of claim 1 further comprises means for sending caller identification information or caller announcement control information to the telephone line or a local line to other equipment or devices.

6. The telephone caller identification control unit of claim 1 further comprises means to display caller information or caller group information.

7. The telephone caller identification control unit of claim 1 further comprises means to suppress ringing signals from the telephone central office or a PBX system.

8. A telephone caller identification control device, module, subsystem, or system unit comprising:
(a) means for extracting caller identification or caller-waiting identification information from a telephone line;
(b) means for announcing a telephone call with a plurality of audible announcement sounds;
(c) means for assigning a plurality of expected caller identifications to a plurality of said audible announcement sounds;
wherein said audible announcement sound is a ringing pattern;
wherein the caller identification control unit announces a telephone call with a first announcement sound for a first expected caller id;
wherein the caller identification control unit announces a telephone call with a second announcement sound for a second expected caller id;
wherein the caller identification control unit announces a telephone call with a third announcement sound for a third expected caller id.

9. The telephone caller identification control unit of claim 8 wherein the caller identification control unit either does not announce or announces with a fourth announcement sound for a telephone call that does not contain an expected caller identification.

10. The telephone caller identification control unit of claim 8 further comprises means to locally or remotely initialize or revise the expected caller list, the announcement sound assignments, or the announcement sound specifications when the telephone is in calling mode, receiving mode, or idle mode.

11. The telephone caller identification control unit of claim 8 further comprises means for receiving caller identification information or caller announcement assignment either on the telephone line or from user commands on the telephone console, and responding to such information accordingly, before or after the telephone is answered by the user or an automatic answering mechanism.

12. The telephone caller identification control unit of claim 8 further comprises means for sending caller identification information or caller announcement control information to the telephone line or a local line to other equipment or devices.

13. The telephone caller identification control unit of claim 8 further comprises means to display caller information or caller group information.

14. The telephone caller identification control unit of claim 8 further comprises means to suppress ringing signals from the telephone central office or a PBX system.

15. A telephone caller identification control device, module, subsystem, or system unit comprising:
(a) means for extracting caller identification or caller-waiting identification information from a telephone line;
(b) means for announcing a telephone call with a plurality of audible announcement sounds;
(c) means for assigning a plurality of expected caller identifications to a plurality of said audible announcement sounds;
wherein said audible announcement sound is a voice segment, or a combination of a ringing pattern and voice segments, some of which may contain the caller description, caller group description, caller location description, or called party description;
wherein the caller identification control unit announces a telephone call with a first announcement sound for a first expected caller id;
wherein the caller identification control unit announces a telephone call with a second announcement sound for a second expected caller id;
wherein the caller identification control unit announces a telephone call with a third announcement sound for a third expected caller id.

16. The telephone caller identification control unit of claim 15 wherein the caller identification control unit either does not announce or announces with a fourth announcement sound for a telephone call that does not contain an expected caller identification.

17. The telephone caller identification control unit of claim 15 further comprises means to locally or remotely initialize or revise the expected caller list, the announcement sound assignments, or the announcement sound specifications when the telephone is in calling mode, receiving mode, or idle mode.

18. The telephone caller identification control unit of claim 15 further comprises means for receiving caller identification information or caller announcement assignment either on the telephone line or from user commands on the telephone console, and responding to such information accordingly, before or after the telephone is answered by the user or an automatic answering mechanism.

19. The telephone caller identification control unit of claim 15 further comprises means for sending caller identification information or caller announcement control information to the telephone line or a local line to other equipment or devices.

20. The telephone caller identification control unit of claim 15 further comprises means to display caller information or caller group information.

21. The telephone caller identification control unit of claim 15 further comprises means to suppress ringing signals from the telephone central office or a PBX system.

22. In combination with a telephone caller identification control device, module, subsystem, or system unit which extracts caller identification or caller-waiting identification information from a first telephone line, transforms the caller identification into a plurality of call announcement control signals, and send said control signals over the first telephone line or a second telephone line, a telephone call announcement device, module, subsystem, or system unit comprising:
(a) means for receiving said call announcement control signals from said first telephone or said second telephone line;
(b) means for announcing a telephone call with a plurality of audible announcement sounds such as a music sequence, a ringing signal, a voice segment, or a combination of sounds, some of which may contain caller description, caller group description, caller location description, or called party description;
wherein the telephone call announcement unit announces a telephone call with a first announcement sound for a first call announcement control signal;
wherein the telephone call announcement unit announces a telephone call with a second announcement sound for a second call announcement control signal;
wherein the telephone call announcement unit announces a telephone call with a third announcement sound for a third call announcement control signal.

23. The telephone call announcement unit of claim 19 further comprises means to initialize or revise the device control settings or the announcement sound specifications upon call announcement control signals when the telephone is in calling mode, receiving mode, or idle mode.

24. The telephone call announcement unit of claim 19 further comprises means to display caller information or caller group information.

25. The telephone call announcement unit of claim 19 further comprises means to suppress ringing signals from the telephone central office or a PBX system.
